(19) United States
(12) Patent Application Publication
(10) Pub. No.: US 2005/0064943 A1
(43) Pub. Date: Mar. 24, 2005

(54) Adjustable roller unit for an internal joint part of a tripod constant-velocity swivel joint

(75) Inventors: Uwe Abraham, Recklinghausen (DE); Peter Jennes, Koln (DE)

Correspondence Address: OSTROLENK FABER GERB & SOFFEN, 1180 AVENUE OF THE AMERICAS, NEW YORK, NY, 100368403, US

(73) Assignee: INA-Schaeffler KG

(21) Appl. No.: 10/990,096

(22) Filed: Nov. 16, 2004

Related U.S. Application Data
(63) Continuation of application No. PCT/EP03/05013, filed on May 14, 2003.

(30) Foreign Application Priority Data
May 17, 2002 (DE) 102 21 978.8

(51) Int. Cl. F16D 3/26

(52) U.S. Cl. 464/124

(57) ABSTRACT

An adjustable roller unit for an internal joint part of a tripod constant-velocity joint. An end of the internal joint part projects into an external joint part. The internal joint part has a bearing journal which is directed radially outward and on which a roller is mounted in a swivelable manner, and the roller is rotatable about the longitudinal axis of the journal. The roller is rotatably mounted on a bearing which is displaceable coaxially to the longitudinal axis of the bearing journal and the mounting permits swiveling of the respective roller on the bearing. The bearing is a linear bearing movable along the journal as the roller swivels. Stops control that movement along the journal.

### CROSS REFERENCE TO RELATED APPLICATION

This is a continuation of International Application No. PCT/EP03/05013, filed May 14, 2003, published in the German language at WO 03/098065, which claims priority from German application No. 102 21 978.8 filed May 17, 2002.

### FIELD OF THE INVENTION

The invention relates to an adjustable roller unit for an internal joint part of a tripod constant-velocity joint, in which the internal joint part, at its end projecting into the external joint part, has a bearing journal which is directed radially outward and on which a roller is in each case mounted in a swivelable manner and so as to be rotatable about its longitudinal axis.

### BACKGROUND OF THE INVENTION

It is known that universal-joint drive shafts are arranged between the differential gear and the drive wheels of a motor vehicle in order to transmit the torque produced by the vehicle engine to the drive wheels of the vehicle. To drive steerable vehicle wheels, such universal-joint drive shafts are equipped at at least one of their ends with a drive joint which produces a uniform rotary drive movement at the vehicle wheels even in the case of comparatively large deflection angles between the wheel-hub longitudinal axis and the drive-shaft longitudinal axis.

Such a drive joint consists of a hollow-cylindrical external joint part with roller raceways on its inner lateral surface, and an internal joint part with a bearing journal oriented radially outward projects into this external joint part. Rollers are slipped onto the bearing journal, and these rollers are generally mounted on the bearing-journal surface via rolling elements and roll in the raceways of the external joint part during deflection movements between the internal joint part and the external joint part.

Even if such tripod joints are able to compensate for the differences in length, which occur on account of said deflection angles, between the wheel-side end of the universal-joint drive shaft and the wheel hub, their noise behavior, in particular in the case of large deflection angles, is unsatisfactory and is acceptable at most for vehicles which have low drive outputs and low requirements with respect to the drive noise behavior.

It is also disadvantageous that, in these simple tripod joints, during the length compensation under deflection, an untidy rolling situation with sliding friction proportions occurs for the roller units on the outer rolling diameter, and this situation should really be avoided.

In order to minimize or entirely eliminate these sliding friction proportions, constant-velocity joints having roller units adjustable at an angle have been developed, which have become known as “AAR joints” (angular adjusted roller). Such an AAR joint is disclosed, for example, by DE 38 14 606 A1 and is shown by way of example in FIG. 5 hereof. This AAR joint 1 has a hollow-cylindrical external joint part 3 which is fastened to an axle shaft 2 and in the inner lateral surface of which raceways 4 for the rollers 6 are formed. Projecting into the external joint part 3 is an axle shaft 11 which, on its joint-side end, generally has three radially projecting journals 5 which have a spherical surface 10 and on which one of these rollers 6 is mounted in each case. During a deflection movement between the internal joint part 1 and the external joint part 3, the roller 6 can move back and forth in the direction of the arrow 27 in the raceways 4 of the external joint part 3.

For mounting on the journal 5, the roller 6 is supported with its inner annular surface on rolling elements 7, which in turn are held in position by a bearing ring 8. In addition, the bearing ring 8, with its inner lateral surface, is mounted in a swivelable manner on the end, of ball-head-shaped design, of the bearing journal 5 in such a way that the roller unit of roller 6, rolling elements 7 and bearing ring 8 can roll in the raceway 4 largely free of sliding friction even in the case of comparatively large deflection angles. However, a disadvantage with this design is that such spherical bearing journals are comparatively expensive and that the bearing surface available in the event of extreme deflection angles between the bearing ring 8 and the bearing journal 5 may be disadvantageously small.

### OBJECT OF THE INVENTION

Against this background, the object of the invention is to present a technically further-developed internal joint part for a tripod joint, in which the adjustment of the rollers as a function of the deflection angle is not effected between a spherical bearing journal and a bearing ring arranged thereon in a swivelable manner.

### SUMMARY OF THE INVENTION

The invention comprises an adjustable roller unit for an internal joint part of a tripod constant-velocity joint. An end of the internal joint part projects into an external joint part. The internal joint part has a bearing journal which is directed radially outward and on which a roller is mounted in a swivelable manner, and the roller is rotatable about the longitudinal axis of the journal. The roller is rotatably mounted on a bearing which is displaceable coaxially to the longitudinal axis of the bearing journal and the mounting permits swiveling of the respective roller on the bearing. The bearing is a linear bearing movable along the journal as the roller swivels. Stops control that movement along the journal.

According to the invention, provision is made for the cylindrical bearing journals, which are formed on the internal joint part and point radially outward, to carry a respective roller. These rollers are displaceable in roller raceways on the inside of a hollow-cylindrical external joint part known per se. In this case, the rollers are each accommodated by a bearing, and these bearings permit low-friction rotation of the rollers on the bearing journals on the one hand, but on the other hand also allow the rollers to be capable of being swiveled or tilted with respect to these bearings. In addition, provision is made for the bearings to be displaceable on the respective bearing journal coaxially to the longitudinal axis of the bearing journal.

Such an adjustable roller unit is preferably includes the rollers being rotatably mounted on rolling elements which are swivelable relative to the respective bearing journal about an axis which is oriented perpendicularly to the longitudinal axis of the bearing journal and perpendicularly to the surface normal of the bearing-journal lateral surface. In this case, the inner lateral surface of the rollers, and/or the exterior of the rolling elements have a circular-arc-shaped or barrel-shaped cross-sectional geometry, so that optimum contact between the surface of the rolling elements and the inside of the roller is retained during swiveling of the roller.

In addition, the rolling elements preferably roll on a correspondingly shaped outer raceway on a bearing inner ring, which sits with its inner lateral surface on the bearing journal. The bearing inner ring is in this case displaceable together with the rolling elements and the roller in the manner of a linear plain bearing coaxially to the longitudinal axis of the bearing journal on its lateral surface.

In a special configuration of the invention, rolling elements are arranged between the inner lateral surface of the inner ring and the lateral surface of the bearing journal in order to form a linear rolling-contact bearing, with which rolling elements the roller unit can be displaced in an especially low-friction manner coaxially to the longitudinal axis of the bearing journal.

Finally, there may be stops arranged on the lateral surface of the bearing journal to the right and left sides of the adjustable roller unit. These stops limit the displacement path of the roller unit on the bearing journal. In a special configuration of the invention, the stops consist of stop rings which, for assembly and dismantling of the roller unit, are detachably fastened to the bearing journal.

Other features and advantages of the present invention will become apparent from the following description of the invention which refers to the accompanying drawings.

### BRIEF DESCRIPTION OF THE DRAWINGS

The invention can be explained with reference to two practical exemplary embodiments which are shown in the attached drawing, in which:

FIG. 1 shows a schematic cross section through a bearing journal of a roller of a tripod joint having a linear plain bearing at a deflection angle of zero degrees,

FIG. 2 shows an illustration as in FIG. 1 but at a large deflection angle,

FIG. 3 shows a schematic cross section through a bearing journal for a roller of a tripod joint having a linear rolling-contact bearing at a deflection angle of zero degrees,

FIG. 4 shows an illustration as in FIG. 3 but at a large deflection angle, and

FIG. 5 shows a cross section through an AAR joint according to the prior art.

### DETAILED DESCRIPTION OF PREFERRED EMBODIMENTS

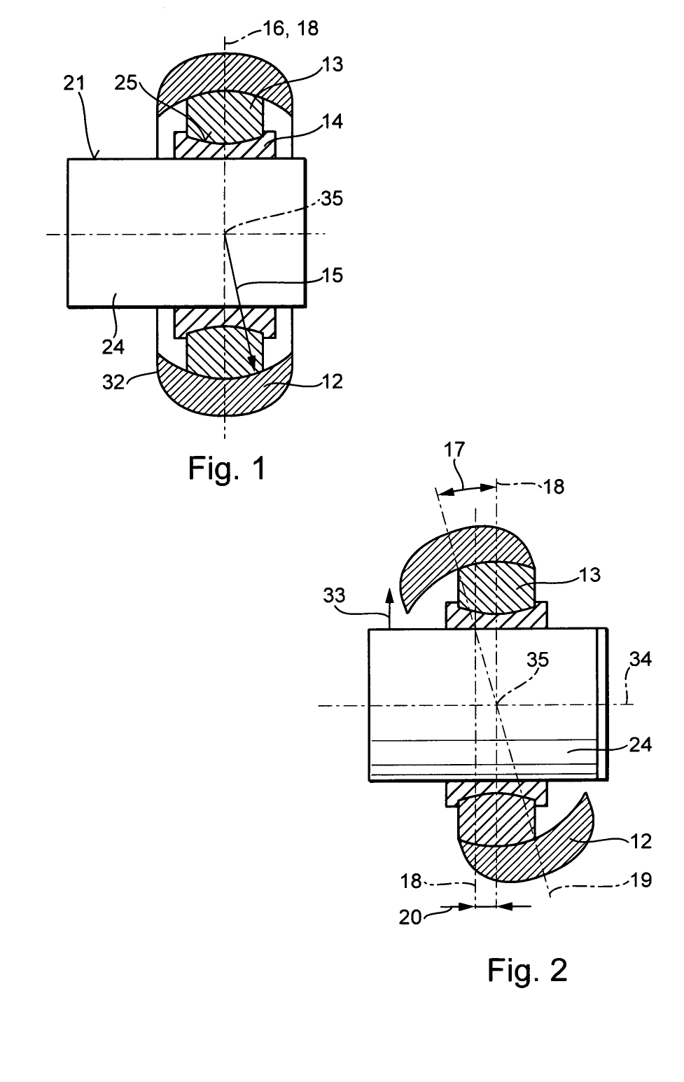

FIG. 1 shows a schematic cross section through an adjustable roller unit according to the invention for a tripod constant-velocity swivel joint. This roller unit comprises a roller 12, rolling elements 13 and an inner ring 14. This roller unit is slipped with the inner ring 14 onto a cylindrical bearing journal 24 of an internal joint shaft (not shown in more detail here) and can be displaced like a plain bearing coaxially on the bearing journal 24.

In addition, this inner ring 14, on its outer circumference, has a rolling-element raceway 25 in which the rolling elements 13 can roll. The rolling elements 13 are preferably of barrel-shaped design, so that their roller surface has an approximately circular-arc-shaped cross-sectional geometry. Arranged radially above the rolling elements 13 is the roller 12, the inner lateral surface 32 of which, in cross section, likewise has a circular-arc-shaped geometry with a radius 15 relative to a swivel axis 35 of the roller 13. Provision is preferably made for the cross-sectional geometry of the rolling-contact surface of the rolling elements 13 to also have just such a radius 15.

This roller unit of raceway roller 12, rolling elements 13 and inner ring 14 are oriented relative to one another in such a way that, in the case in which the driving and the driven shafts of the tripod constant-velocity joint have no deflection angle relative to one another, the center line 16 of the rolling element 13 and of the inner ring 14 and the center 18 of the roller 12 are oriented so as to lie one above the other (see FIG. 1).

Swiveling of the driven shaft relative to the driving shaft of the tripod joint, for instance when negotiating a curve with a front-drive vehicle, leads to the internal joint part and the external joint part being deflected relative to one another. In order to compensate for this deflection from the drive engineering point of view, provision is made according to the invention, as shown in FIG. 2, for the roller 12 arranged there to be mounted on the rolling elements 13 in such a way that it can be swiveled by a swivel angle 17. In this case, the swivel movement of the roller 13 is effected about a swivel axis 35, which is perpendicular to the longitudinal axis 34 of the bearing journal 24 and perpendicular to the surface normal 33 on the journal lateral surface 21.

At the same time as the roller 12 is swiveled by the swivel angle 17, the inner ring 14 together with the rolling elements 13 mounted thereon moves like a plain bearing on the lateral surface 21 of the bearing journal 24 coaxially to its longitudinal axis 34. In the process, the displacement path 20 of the inner ring 14 on the bearing-journal lateral surface 21 depends, inter alia, on the size of the swivel angle 17. In the exemplary embodiment shown in FIG. 2, the inner ring 14 has been displaced by a distance 20 when the center line 19 of the swiveled roller 12 assumes the position shown there.

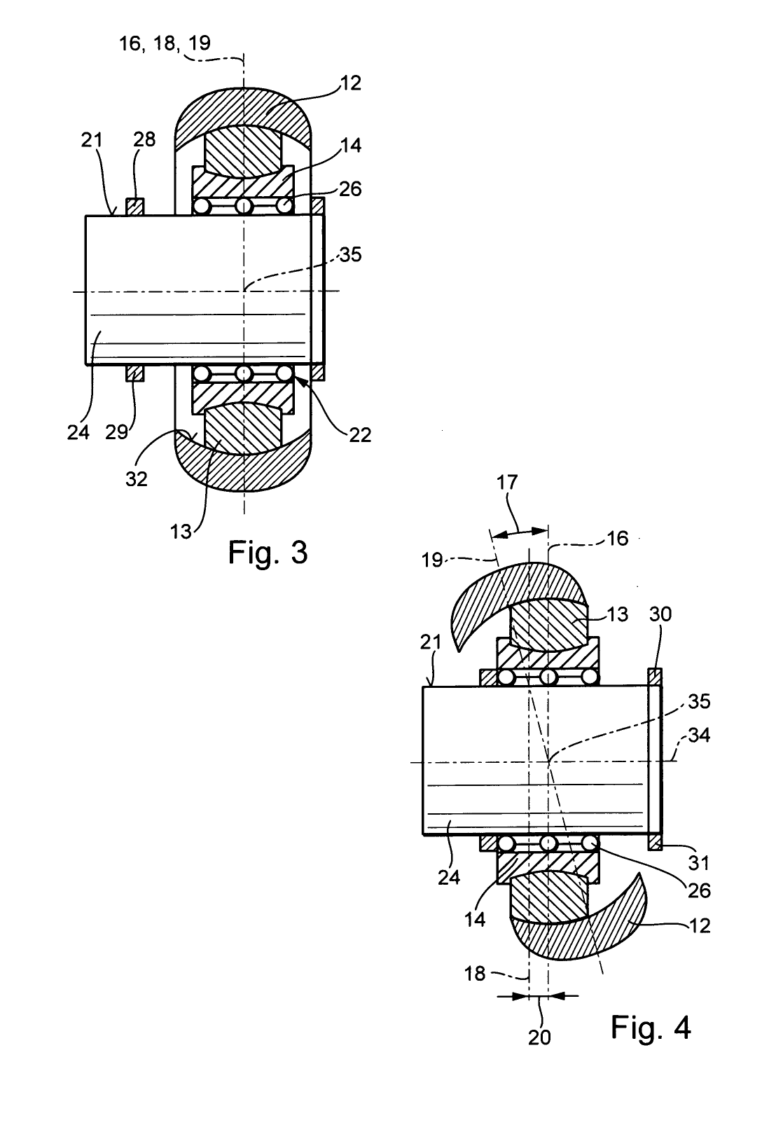

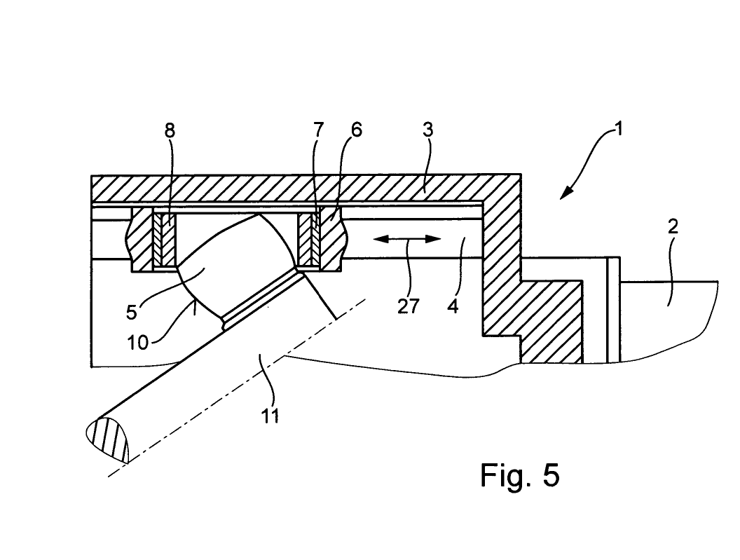

The same circumstances are also shown in the exemplary embodiment according to FIGS. 3 and 4, in which, however, instead of a plain bearing, a linear rolling-contact bearing 22 having rolling elements 26 is arranged between the inner ring 14 and the bearing journal 24. Here, too, the bearing inner ring 14, during a deflection of internal joint part and external joint part relative to one another, performs an axial displacement movement along a displacement path 20, while the roller 12 moves by a swivel angle 17 away from its non-deflected position into the swivel position 19 shown.

To limit the maximum displacement path 20, stops 28 to 31 may be arranged on the journal lateral surface 21, these stops 28 to 31 being designed, for example, as stop rings 28, 29 and 30, 31. In this case, these stop rings 28, 29; 30, 31 are positioned on the left side and right side of the roller unit 12, 13, 14, 22 and, in a particular embodiment of the invention, engage in annular grooves (not shown in any more detail here) in the journal lateral surface 21. For assembly and dismantling purposes, the stop rings 28, 29; 30, 31 are preferably detachably fastened to the bearing journal 24.

The novel roller unit 12, 13, 14, 22 for constant-velocity tripod joints is distinguished in particular by the fact that markedly larger deflection angles can be achieved with it, with otherwise comparable dimensions (for example of the bearing journals 24). This is made possible in particular by the angular adjustment of the rollers 12 not being effected on a spherically formed bearing journal but by being effected virtually in the rolling-element raceways of the external joint part. For this purpose, the roller 12, according to one aspect of the invention, has on its inner lateral surface a rolling-contact-bearing raceway 32 which is symmetrically spherical relative to the rotation axis and in which the correspondingly designed rolling elements 13 roll with low friction, which overall makes possible easy and low-friction angular compensation.

Since the deflection of the joint requires a linear movement of the locating journal 24, the inner ring 14 of the roller unit is designed as a linear bearing. The latter may be both a plain bearing and a rolling-contact bearing and can be adapted to the vibration requirements of the respective vehicle type.

1. An adjustable roller unit for an internal joint part of a tripod constant-velocity joint, comprising
an external joint part;
an internal joint part having an end projecting into the external joint part, a bearing journal on the end of the internal joint part, the journal being directed radially outward;
a roller mounted on the journal and mounted in a swivelable and rotatable manner with respect to the journal;
a bearing on which the roller is rotatably mounted; the bearing is displaceable coaxially to a longitudinal axis of the bearing journal and the bearing and the roller thereon are shaped to permit swiveling of the respective roller on the bearing.

2. The adjustable roller unit as claimed in claim 1, wherein the bearing journal has a cylindrical cross-sectional geometry.

3. The adjustable roller unit as claimed in claim 1, wherein the bearing comprises a plurality of rolling elements on which the roller is rotatably and swivelably mounted and the rolling elements are supported on the journal; the bearing journal has an outward lateral surface at which the bearing is disposed; and
the roller is swivelable relative to the bearing journal and about an axis which is oriented perpendicularly to the longitudinal axis of the bearing journal and perpendicularly to a surface normal of the bearing-journal lateral surface.

4. The adjustable roller unit as claimed in claim 3, wherein the rolling elements each have a barrel-shaped cross-sectional geometry.

5. The adjustable roller unit as claimed claim 3, further comprising a bearing inner ring around the bearing journal, the inner ring having a radially outwardly facing rolling-element raceway; the rolling elements roll in the raceway formed outside the inner ring.

6. The adjustable roller unit as claimed in claim 5, wherein the bearing inner ring is mounted on the bearing journal in the manner of a linear bearing.

7. The adjustable roller unit as claimed in claim 6, further comprising second rolling elements which form a linear rolling-contact bearing and are arranged between the bearing ring and the bearing journal.

8. The adjustable roller unit as claimed in claim 6, wherein the roller has an inner lateral surface and the rolling elements have respective outer lateral surfaces which contact the inner lateral surface; at least one of the outer and the inner lateral surfaces of the rollers and the rolling elements respectively has a circular-arc-shaped cross-sectional geometry.

9. The adjustable roller unit as claimed in claim 8, wherein at least one of the outer and the inner lateral surfaces has a radius relative to the swivel axis.

10. The adjustable roller unit as claimed in claim 6, further comprising stops formed on the bearing-journal lateral surface for limiting axial movement of the bearing.

11. The adjustable roller unit as claimed in claim 10, wherein the stops comprise stop rings which are detachably fastened to the lateral surface of the bearing journal.

12. The adjustable roller unit as claimed in claim 3, wherein the roller has an inner lateral surface and the rolling elements have respective outer lateral surfaces which contact the inner lateral surface; at least one of the outer and the inner lateral surfaces of the rollers and the rolling elements respectively has a circular-arc-shaped cross-sectional geometry.

13. The adjustable roller unit as claimed in claim 3, further comprising stops formed on the bearing-journal lateral surface for limiting axial movement of the bearing.

14. The adjustable roller unit as claimed in claim 13, wherein the stops comprise stop rings which are detachably fastened to the lateral surface of the bearing journal.
